(19) United States
(12) Patent Application Publication
(10) Pub. No.: US 2008/0306621 A1
(43) Pub. Date: Dec. 11, 2008

(54) SEMICONDUCTOR MANUFACTURING APPARATUS CONTROL SYSTEM AND STATISTICAL PROCESS CONTROL METHOD THEREOF

(76) Inventors: Sang-Wook Choi, Bucheon-si (KR); Seung-Hoon Tong, Seoul (KR); Hyung-Sun Kim, Suwon-si (KR); Hyun-Cheol Lee, Seongnam-si (KR); Ho-Young Lee, Seoul (KR)

Correspondence Address: F. CHAU & ASSOCIATES, LLC, 130 WOODBURY ROAD, WOODBURY, NY, 11797, US

(21) Appl. No.: 12/133,849

(22) Filed: Jun. 5, 2008

(30) Foreign Application Priority Data
Jun. 5, 2007 (KR) 2007-55071

(51) Int. Cl. G06F 19/00

(52) U.S. Cl. 700/110

(57) ABSTRACT

A semiconductor manufacturing apparatus control system and a statistical process control method thereof increase reliability. A semiconductor manufacturing apparatus control system includes a plurality of unit process devices for performing various semiconductor unit processes; a plurality of measuring devices for measuring a pattern characteristic of wafer completed in respective unit processes in the plurality of unit process devices; and a host computer for sensing an abnormal state of the unit process by using a T² statistic computed by a plurality of process variables corresponding to the pattern characteristic of the wafer measured in the plurality of measuring devices, thereby realizing a monitoring of all unit processes including a measuring process to which a skip rule is applied, and thus enhancing reliability.

### CROSS REFERENCE TO RELATED APPLICATION

This application claims priority under 35 U.S.C. § 119 from Korean Patent Application 10-2007-0055071, filed on Jun. 5, 2007, the contents of which are hereby incorporated by reference in their entirety for all purposes as if fully set forth herein.

### BACKGROUND AND SUMMARY

1. Technical Field

The present disclosure relates to controlling the manufacturing of semiconductor devices and, more particularly, to a semiconductor manufacturing apparatus control system and a statistical process control method thereof, which is capable of sensing an abnormality in a semiconductor manufacturing process by using a multivariate statistical process control method, and of analyzing the cause of the sensed abnormality.

2. Discussion of Background

Recently, the trend has been to decrease a minimum line width applied to a semiconductor integrated circuit manufacturing process, so as to increase an operating speed of the semiconductor chips and to increase an information storing capacity per unit area in the semiconductor manufacturing industries. Additionally, the size of the semiconductor devices, such as the number of transistors integrated on a semiconductor wafer, has become miniaturized to a sub half micron or below. For example, a critical dimension (CD) of a semiconductor device, and a feature size having a relatively more important level relating to a process speed, are being reduced, and also the size of the substrate is being increased to around 200 mm to 300 mm or more. Thus, the feature size based on an integration increase of the semiconductor device is reduced, and the size increase of substrate for the fabrication of semiconductor devices becomes a burden in the semiconductor fabrication process.

Such semiconductor devices may be fabricated by performing several of such processes, such as deposition, photo, etching and diffusion. Furthermore, there may be many respective variables in the several processes, thereby influencing the process result.

For example, the photo process requires various process variables, such as a specific resolution, depth of focus, overlay and the like on photoresist formed on a wafer. Such resolution, depth of focus, and overlay are decided according to the resources of the exposing device, such as a refraction rate, waveform of incident light, and an opening rate of the lens through which incident light is shrunk and projected, relative to the photoresist formed on the wafer. Furthermore, the photo process may be decided by a control of the exposing device and a peripheral environment, such as a length of focus and the temperature. Such process variables are combined and appear in a photo process, and this exerts an important influence upon the result of the photo process.

The result of the photo process can be represented as an image type by performing an electrical or optical precise measurement through an electron microscope or optical microscope such as an SEM and a TEM, for enlarging a projection on the surface of the wafer performed in a photo process and the surface and sectional face of the wafer is completed in an etching process performed after the photo process. It is possible to trace the process variables, such as resolution, depth of focus, overlay, and the like through the photo process result of the image. For example, the process variables traceable through the photo process result may involve tens of kinds of process variables.

In a semiconductor manufacturing apparatus control system according to the conventional art, measurement values and determination values of a plurality of process variables traced through the process result completed in corresponding unit processes correspond mutually, one by one, in a univariate control method, thereby controlling a normal or abnormal state and performing a feedback for process variables of the normal state in a subsequent unit process. At present, the univariate control method can be applied to only a corresponding unit process, thus research and development on a multivariate statistical process control method considering a correlation between previous and subsequent unit processes has been actively undertaken.

On the other hand, a wafer is fabricated to produce 500 or more different chip patterns, and the wafer as completed in the photo process undergoes a precision test on 20 to 30 portions thereof. The precision test requires a relatively long period of time.

Accordingly, when the precision process is executed for all wafers that undergo a corresponding photo process, productivity may be lowered. Thus, the precision test may be regularly performed on only a given number of wafers that are completed in the photo process, or may be performed randomly for selected ones among a plurality of wafers. For example, in a batch type semiconductor fabrication process performed on about 25 sheets of wafers held as one lot in a cassette or carrier, one wafer may be taken out of one lot and may then undergo the precision test.

A long period of time is taken, however, in executing the measurement in a semiconductor process, thus inevitably a portion of the variables is not always measured for every lot and the measurement is frequently skipped according to a given skip rule, in order to increase productivity.

In such a statistical process control method of a conventional semiconductor manufacturing apparatus control system, only lots measured for all variables can be controlled and the control of lots partially measured is difficult, thus there is a problem of lowered reliability.

### SUMMARY OF THE INVENTION

Accordingly, exemplary embodiments of the present invention provide a semiconductor manufacturing apparatus control system and a multivariate statistical process control method thereof, which is capable of performing a control process of all lots even in a skip status in which the measurement for a portion of the variables is not performed, thereby increasing reliability.

According to exemplary embodiments of the present invention, a semiconductor manufacturing apparatus control system comprises a plurality of unit process devices for performing various semiconductor unit processes; a plurality of measuring devices for measuring a pattern characteristic of a wafer completed in respective unit processes in the plurality of unit process devices; and a host computer for sensing an abnormal state of a unit process by using a T² statistic computed by a plurality of process variables corresponding to the pattern characteristic of the wafer measured in the plurality of measuring devices.

The host computer comprises a modeling selection module for selecting an adequate model according to the number and type, or kind, of the plurality of process variables corresponding to a pattern characteristic of the wafer measured in the control process in the plurality of measuring devices; a control limit determination module for computing a T² control chart and a control limit by using the plurality of process variables selected in the modeling selection module; and an abnormality sensing module for computing a T² statistic by using a plurality of process variables corresponding to the pattern characteristic of the wafer measured in the plurality of measuring devices in a fabrication process, and checking whether there exists an item of the T² statistic that deviates from the control limit, and then deciding whether the unit process has an abnormal state.

According to an exemplary embodiment of the present invention, a semiconductor manufacturing apparatus control system comprises a plurality of unit process devices for performing various semiconductor unit processes; a plurality of measuring devices for measuring a pattern characteristic of the wafer completed in respective unit processes in the plurality of unit process devices; and a host computer for sensing an abnormal state of the unit process by using a T² statistic and a Q statistic computed by a plurality of process variables corresponding to the pattern characteristic of the wafer measured in the plurality of measuring devices.

According to an exemplary embodiment of the present invention, a multivariate statistical process control method for use in a semiconductor manufacturing apparatus control system comprises collecting reference data corresponding to a surface characteristic of a wafer from a plurality of measuring devices in a control process; determining or modeling a given reference value by using the reference data; computing a T² control chart and a control limit by using the reference value; collecting measurement data from a plurality of measuring devices in a fabrication process; and computing a measurement value and the T² statistic by using the measurement data, and checking whether there exists an item of the T² statistic that deviates from the control limit and then deciding whether the unit process has an abnormal state.

According to an exemplary embodiment of the present invention, a multivariate statistical process control method for use in a semiconductor manufacturing apparatus control system comprises collecting reference data corresponding to a surface characteristic of a wafer from a plurality of measuring devices in a control process; determining or modeling a given reference value by using the reference data; computing a T² control chart and a Q control chart and respective control limits by using the reference value; collecting measurement data from a plurality of measuring devices in a fabrication process; and computing a measurement value and a T² statistic and a Q control chart by using the measurement data, and checking whether there exists an item of the T² statistic and the Q control chart that deviates from the control limit and then deciding whether the unit process has an abnormal state.

### BRIEF DESCRIPTION OF THE DRAWINGS

Exemplary embodiments of the present invention will be understood in more detail from the following descriptions taken in conjunction with the accompanying drawings that are given by way of illustration only, and thus are not limitative of the present invention, and wherein:

FIG. 1 schematically illustrates a semiconductor manufacturing apparatus control system according to an exemplary embodiment of the present invention;

FIG. 2 illustrates an oval showing a statistical distance c from a mean vector;

FIG. 3 provides a comparison between a univariate control chart and a T² control chart;

FIG. 4 depicts a host computer;

FIG. 5 illustrates an orthogonal coordinate system of a principal component analysis (PCA);

FIG. 6 illustrates an example of keeping only two principal components in a PCA;

FIG. 7 illustrates a decomposed observation vector in an orthogonal coordinate system of a PCA; and

FIG. 8 is a flowchart providing a multivariate statistical process control (SPC) method of a semiconductor manufacturing apparatus control system according to an exemplary embodiment of the present invention.

### DETAILED DESCRIPTION OF EXEMPLARY EMBODIMENTS

Exemplary embodiments of the present invention now will be described more fully hereinafter with reference to the accompanied drawings, in which exemplary embodiments of the present invention are shown. This invention may, however, be embodied in many different forms and should not be construed as limited to the exemplary embodiments set forth herein. Rather these exemplary embodiments are provided so that this disclosure will be thorough and complete, and will fully convey the scope of the invention to those of ordinary skill in the art.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein. Exemplary embodiments of the present invention are more fully described below with reference to the accompanied drawings. This invention may, however, be embodied in many different forms and should not be construed as being limited to the exemplary embodiments set forth herein; rather, these exemplary embodiments are provided so that this disclosure is thorough and complete, and conveys the concept of the invention to those of ordinary skill in the art. For purposes of clarity, a detailed description of known functions and systems has been omitted.

A semiconductor manufacturing apparatus control system and a multivariate statistical process control method according to exemplary embodiments of the present invention are described as follows.

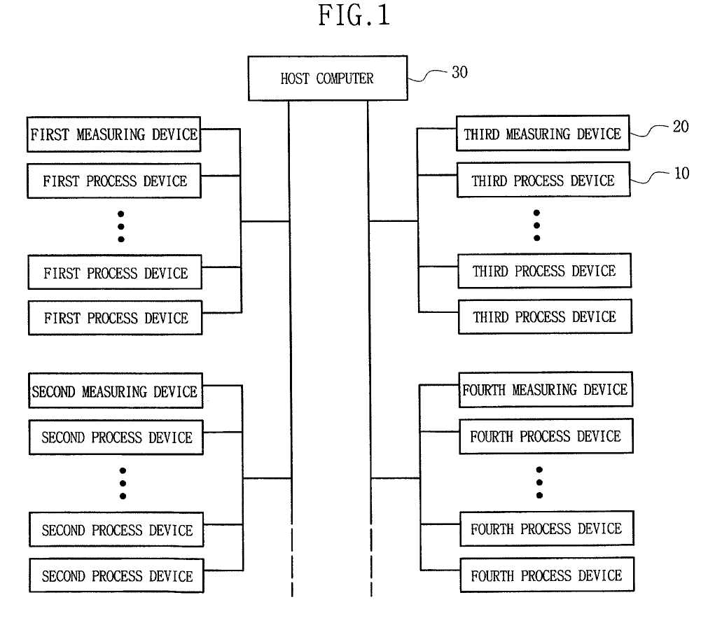

FIG. 1 schematically illustrates a semiconductor manufacturing apparatus control system according to an exemplary embodiment of the present invention.

Referring to FIG. 1, a semiconductor manufacturing apparatus control system largely comprises a plurality of process devices 10 for performing a given unit process for a wafer, a plurality of measuring devices 20 for measuring a characteristic of a wafer completed in the unit process, and a host computer 30 for sending and receiving data to/from the measuring device 20 and the process device 10. Though not shown in the drawings, the control system may further comprise a transfer device for transferring or returning a wafer between the plurality of unit process devices 10 or the plurality of measuring devices 20.

The plurality of process devices 10 comprise unit process devices for individually performing unit processes used in forming a semiconductor device pattern of a given size on a wafer surface. For example, the unit processes comprise a deposition process of depositing a thin film with a given thickness on a wafer, a photo process of forming a mask layer such as photoresist pattern on the thin film deposited in the deposition process, an etching process of etching the thin film or wafer exposed through the mask layer, a polishing process of planarizing the thin film formed on the wafer, and a cleaning process of cleaning byproducts produced in the polishing and etching processes, and the like. Accordingly, in the plurality of process devices 10, the same kinds of processes are adapted in parallel or mutually different kinds of processes are adapted in series, according to the time taken in the unit process and a sequence within a semiconductor production line. The plurality of process devices 10 are provided including a plurality of first equipment computers (not shown) for an automation of the unit processes and for controlling individually the unit processes.

The plurality of measuring devices 20 measure mechanically, optically, and electrically patterns formed on a wafer, so as to obtain a characteristic of the wafer or pattern. The plurality of measuring devices 20 are adapted to be interlocked with the process devices 10 and driven so as to increase a production yield. For example, the measuring device 20 may include an electron microscope, such as an SEM, for measuring a plane surface of the wafer, an optical microscope, such as a TEM, for measuring a sectional face of the wafer, and an X-ray test device. Similarly, the plurality of measuring devices 20 may include a plurality of second equipment computers (not shown) for an automation of the measurement process.

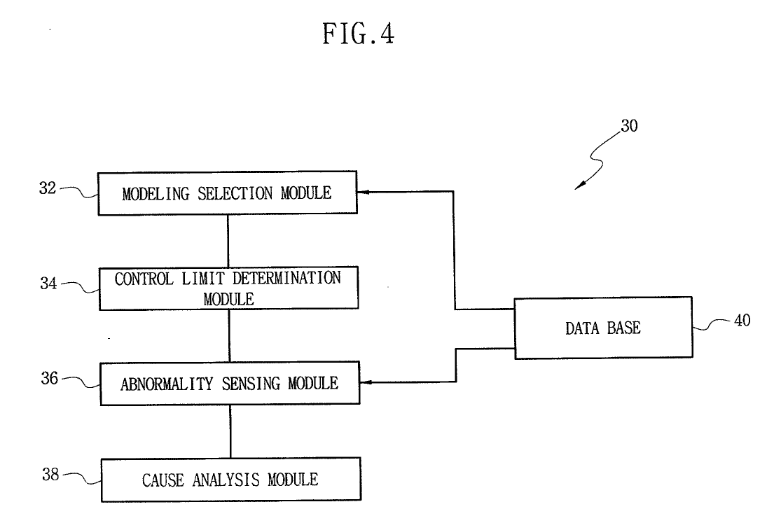

The host computer 30 is provided to entirely and systematically control almost all of the process devices 10 and measuring devices 20 through the entire semiconductor production line. The host computer 30 can check and write all status reports generated in the process devices 10 and the measuring devices 20, and is predetermined to be connected with a subsequent process. For example, the host computer 30 may receive detailed data of the process device 10 and measuring device 20 from first and second equipment computers (not shown), and can store the data in a database 40 shown in FIG. 4. The data stored in the database 40 may be output to the first or second equipment computer through the host computer 30 in response to an output signal received from the first or second equipment computer. For example, the first and second equipment computers and the host computer 30 mutually communicate through a generally well-known communication protocol, TCP/IP (Transmission Control Protocol/Internet Protocol), mutually giving and receiving data. The first and second equipment computers (not shown) and the host computer 30 mutually communicate and share data through the SECS (Semi Equipment Communication Standard) protocol, as the semiconductor equipment standard communication protocol to regulate a mutual communication so as to recognize transmission data and respond to that. Also, the host computer 30 stores data input through the second equipment computer (not shown) in the database 40, computes a T² statistic using the data stored in the database 40, and thus decides whether there is a process error in the process device 10.

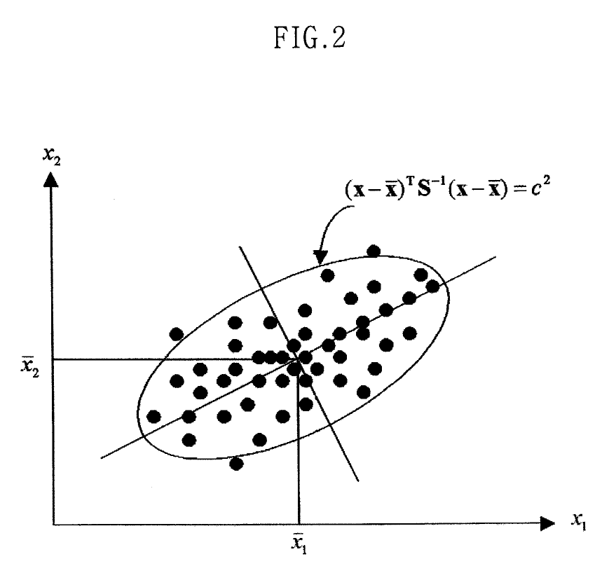

Referring to FIG. 2, the T² statistic has been proposed by Hotelling, and is widely used as a multivariate statistical process control method (hereinafter, referred to as ‘SPC’). The T² statistic indicates herein a generalized distance from a mean vector x of an observation vector x comprised of a p-number of variables, and is defined as the following mathematical formula 1.

T²=(x−x)^{T}S⁻¹(x−x) (Mathematical Formula 1)

Wherein S is a sample covariance matrix, and x is an observation vector that may be represented as the following mathematical formula 2.

X^{T}=[x₁, x₂, . . . , xₚ] (Mathematical Formula 2)

When multivariate observed-values are obtained at the n-number of mutually different time points, the entire data may be represented as an (n×p) matrix X of the mathematical formula 1. Each row of the matrix X is an observation vector measured at one time point, and each column is an entire observed-value of a corresponding variable and can be represented as mathematical formula 3.

$$X = [ \begin{matrix}{x}_{11} & {x}_{12} & {x}_{13} & … & {x}_{1}^{T} \\ {x}_{21} & {x}_{22} & {x}_{23} & … & {x}_{2}^{T} \\ {x}_{31} & {x}_{32} & {x}_{33} & … & {x}_{3}^{T}\end{matrix} ] \qquad ( Mathematical Formula 3 )$$

The observation vector is herein x^{T}=[x₁, x₂, x₃, . . . , xₚ], and the mean vector is x^{T}=[x₁, x₂, x₃, . . . , xₚ], wherein xⱼ indicates a mean of the j-th column of matrix X of the mathematical formula 3. Thus, the sample covariance matrix S can be represented as the following mathematical formula 4 using a matrix X of the mathematical formula 3.

$$S = \frac{{\sum }_{i = 1}^{n} ( {x}_{1 -} \underline{x} ) {( {x}_{i} - \underline{x} )}^{T}}{n - 1} \qquad ( Mathematical Formula 4 )$$

Thus, a T² statistic is a scale of distance that an observation vector x is distanced from a mean vector x in a p-dimensional space. The T² statistic is provided considering a correlation between variables by using an inverse matrix of a covariance matrix like the mathematical formula 1 when calculating the distance. Such distance considering the correlation of variables is called a statistical distance, to be distinguished from a Euclidean distance of the p-dimensional space. For example, when it is a bivariate, p=2, points having the same statistical distance from a mean vector x^{T}=[x₁, x₂] have the shape of an oval as shown in FIG. 2, considering a correlation of the two variables x₁ and x₂, and all points of the overall space have the same T² value.

At this time, when process variables are based on a multivariate normal distribution, the T² statistic is based on an F distribution represented by the following mathematical formula 5.

$$\frac{n ( n - p )}{( {n}^{2} - 1 ) p} {T}^{2} ∼ F ( p , n - p ) \qquad ( Mathematical Formula 5 )$$

Then, a control limit of a T² control chart can be calculated as in the following mathematical formula 6 by using the F distribution.

$${UCL}_{{T}^{2}} = \frac{( {n}^{2} - 1 ) p}{n ( n - p )} {F}_{a} ( p , n - p ) \qquad ( Mathematical Formula 6 )$$

Fₐ(p, n−p) is herein a (1-a) quantile of the F distribution having p and (n−p) degrees of freedom. The T² control chart is relatively more sensitive to a process variation, as compared with independently controlling respective process variables by using the p-number of univariate control charts, by considering a correlation between process variables.

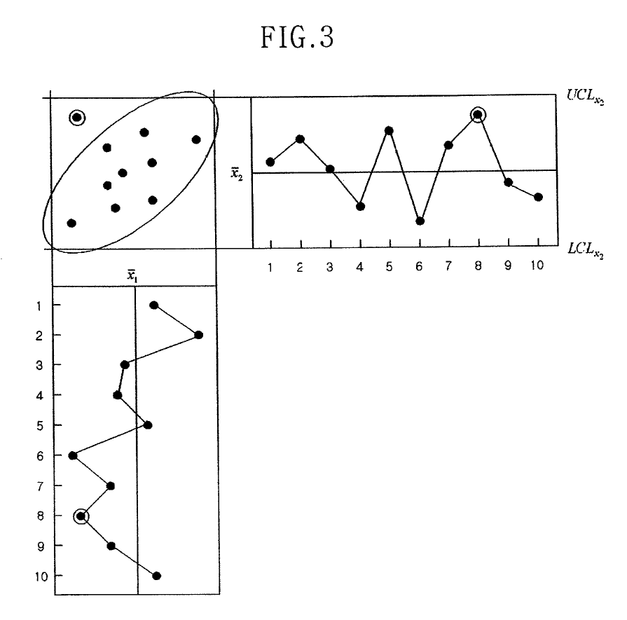

FIG. 3 provides a comparison between a process control using two univariate control charts and a process control using a T² control chart, disregarding a correlation between two variables x₁ and x₂. Though an abnormality signal is not generated in the univariate control chart, in the T² control chart an eighth observed-value may be decided as being deviated from a normal state by considering a correlation between variables.

Thus, the host computer 30 can easily detect a process error that is otherwise impossible to observe in the univariate process control method, by using the T² statistic of the multivariate statistical process control (SPC) method.

For example, the host computer 30 obtains a reference T² control chart and a control limit through a control process, and also obtains a measurement T² control chart through a measurement process of an actual fabrication process, and then compares the reference T² control chart and the control limit with the measurement T² control chart, and thus senses an abnormality.

FIG. 4 depicts the host computer 30. The host computer 30 comprises a modeling selection module 32 for collecting control or reference data in a control process and determining a reference value, a control limit determination module 34 for determining a control limit and a reference T² control chart from the reference value determined in the modeling selection module 32, and an abnormality sensing module 36 for collecting measurement data in a fabrication process to obtain a T² statistic and a measurement T² control chart, and projecting them to the reference T² control chart and the control limit, and thus sensing an abnormality in the process.

The host computer 30 further comprises a cause analysis module 38 for analyzing a process variable corresponding to an item in which the T² statistic is deviated from the control limit when an abnormality is sensed in the abnormality sensing module 36.

The modeling selection module 32 may collect data stored in a database 40 in a second equipment computer (not shown), and may produce a matrix X of the mathematical formula 2 shown hereinabove and determines it as a reference value. For example, the modeling selection module 32 may determine a column or row of the matrix X through a classification as a first model performing a measurement process for every lot, and a second model having a measurement process skipped by a given skip rule. The first and second modes are separately controlled and may be computed as mutually different T² statistics.

Accordingly, a semiconductor manufacturing apparatus according to an exemplary embodiment of the present invention employs the modeling selection module 32 that performs a model classification, as a first model performing a measurement process for every lot, and a second model having a measurement process skipped according to a skip rule, and uses the host computer 30 for applying a T² statistic based on respective models, thereby controlling all measurement and unit processes, even in a skip status wherein a measurement of variables is partially performed and so enhancing reliability.

The control limit determination module 34 may estimate a covariance matrix S and a mean vector x of a control state from reference matrix X determined in the modeling selection module 32, and may determine a reference T² control chart and a control limit. For example, the reference T² control chart may be determined like in mathematical formula 1 shown hereinabove, and the control limit may be determined like in mathematical formula 5 shown hereinabove. As described below, the reference T² control chart is referred to as a T² control chart and the measurement T² control chart is referred to as a T² statistic.

The abnormality sensing module 36 collects data stored in the database 40 of the host computer 30 through a second equipment computer (not shown) in an actual fabrication process, and obtains a measurement T² control chart based on the mathematical formula 1, and compares the reference T² control chart and control limit, thereby sensing an abnormality of the process.

Accordingly, a semiconductor manufacturing apparatus control system according to an exemplary embodiment of the present invention selects a model according to the kind of measurement processes to which the skip rule is applied, and uses a T² statistic based on that, thereby controlling the determination of an abnormality of the process.

The T² control chart may cause a difficulty in using a general T² statistic for a process control when there exists collinearity as a linear functional relation between process variables or when there are many process variables. When there exists the collinearity between process variables, a correlation between variables becomes very great and so a problem is partially caused in obtaining an inverse matrix of the covariance matrix S. When there are many process variables to be measured, the size (p×p) of the covariance matrix S that must be stored for a computation of the T² statistic increases. Further, in collecting large scale process data, several process variables for a process state at one time point are repetitively measured, thus there generally exists collinearity between process variables. As described above, when the general T² control chart cannot be used, a principal component analysis (hereinafter, referred to ‘PCA’) control chart is used in the process control.

Reference matrix X used to determine the PCA control chart has a structure similar to a matrix X of the T² control chart. A reference matrix X similar to the mathematical formula 2 shown hereinabove is provided by using the n-number of process variable data measured in the control state. A matrix X_{c} produced by deducting a mean of a corresponding column from each column of reference matrix X can be represented as the following mathematical formula 7.

$$\begin{matrix}{X}_{c} = [ \begin{matrix}( {x}_{11} - \underline{{x}_{1}} ) & ( {x}_{12} - \underline{{x}_{2}} ) & … & {x}_{1 p} - \underline{{x}_{p}} \\ ( {x}_{21} - \underline{{x}_{1}} ) & ( {x}_{22} - \underline{{x}_{2}} ) & … & {x}_{2 p} - \underline{{x}_{p}} \\ ( {x}_{31} - \underline{{x}_{1}} ) & ( {x}_{32} - \underline{{x}_{2}} ) & … & {x}_{3 p} - \underline{{x}_{p}}\end{matrix} ] \\ = [ \begin{matrix}{( {x}_{1} - \underline{x} )}^{T} \\ {( {x}_{2} - \underline{x} )}^{T} \\ ⋮ \\ {( {x}_{n} - \underline{x} )}^{T}\end{matrix} ]\end{matrix} \qquad ( Mathematical Formula 7 )$$

A sample covariance matrix S is obtained like in the following mathematical formula 8 by using the matrix X_{c} of the mathematical formula 7.

s=xₑ^{T}xₑ/(n−1) (Mathematical Formula 8)

The PCA control chart is a method of defining new variables that become orthogonal through the PCA, projecting an observed-value of process variables into a principal component space of low dimension formed by such variables, and then writing a control chart. The PCA used as the method of dimension reduction in the PCA control chart indicates a multivariate technique analyzing a correlation between multivariate variables.

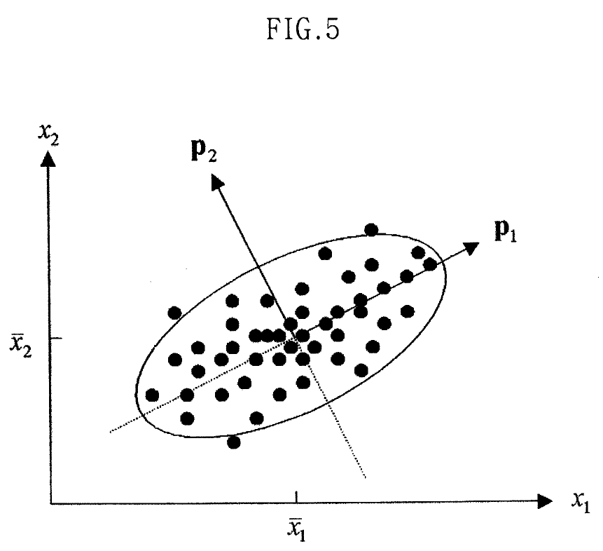

The PCA defines mutually-orthogonal coordinate axes, sequentially from a coordinate axis designating a maximum variation, and analyzes a correlation between variables by converting observation vectors into a new coordinate system. A new coordinate axis is defined by a ‘loading pₐ, a=1, . . . , p’, and the (px1) vector pₐ is a unit vector of a coordinate axis indicating an a-th variation. FIG. 5 illustrates an orthogonal coordinate system using the PCA, which indicates a principal component space defined by considering a correlation between two variables when it is a bivariate (p=2).

Loading pₐ indicates an a-th eigenvalue of the covariance matrix S, and λₐ indicates a variation level provided by an a-th principal component. A principal component score tₐ indicates a coordinate value that an observation vector x is projected as the a-th principal component, and this can be represented as the following mathematical formula 9.

tₐ=pₐ^{T}(x−x), a=1, . . . p (Mathematical Formula 9)

The T² statistic of the mathematical formula 1 can be expressed in a mathematical formula 10 by using a principal component score tₐ.

$${T}^{2} = {( x - \underline{x} )}^{T} {S}^{- 1} ( x - \underline{x} ) = {\sum }_{a = 1}^{b} \frac{{t}_{a}^{2}}{{λ}_{a}} \qquad ( Mathematical Formula 10 )$$

Thus, a T² value computed by using the observation vector x and a T² value computed by using all principal component scores tₐ, a=1, . . . , p are equal to each other.

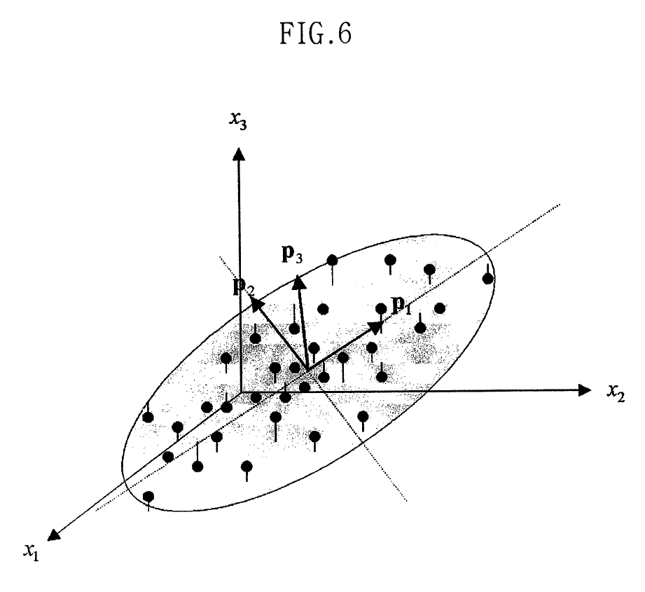

The PCA uses only the A(<p)-number of principal components indicating a maximum variation among the total p-number of principal components. When there exists collinearity between process variables or when there are many process variables, most of the process variations can be explained with only a small quantity of principal components. FIG. 6 illustrates an example of keeping only two principal components in a PCA, and herein most of the variations can be explained with only two principal components corresponding to plane coordinates of p₁ and p₂.

In using only the A-number of principal components, the T² statistic of the mathematical formula 10 can be decomposed into two components, as illustrated in the following mathematical formula 11.

$${T}^{2} = {T}_{A}^{2} + {Q}_{a = A + 1}^{p} \frac{{t}_{a}^{2}}{{λ}_{a}} \qquad ( Mathematical Formula 11 )$$

When computing herein by using only the A-number of principal component scores, the T_{A}² statistic can be represented in the following mathematical formula 12.

$${T}_{A}^{2} = {Q}_{a = 1}^{A} \frac{{t}_{a}^{2}}{{λ}_{a}} \qquad ( Mathematical Formula 12 )$$

The T_{A}² statistic indicates a statistical distance between a point whereat an observation vector x is projected into an A-dimensional principal component space, and a mean vector x.

PCA is based on the fact that a reference matrix X_{c} can be decomposed through a singular value decomposition (SVD), as shown in the following mathematical formula 13.

$${X}_{c} = {Q}_{a = 1}^{A} {t}_{a} {p}_{a}^{T} + {Q}_{a = A + 1}^{p} {t}_{a} {p}_{a}^{T} = \hat{X} + E \qquad ( Mathematical Formula 13 )$$

The (nx1) vector tₐ is an a-th principal component score vector, and is represented by the following mathematical formula 14.

tₐ=X_{c}pₐ, a=1, 2, . . . , p (Mathematical Formula 14)

The matrix \hat{x} in the mathematical formula 14 is obtained by estimating a matrix X_{c} through use of the A-number of principal components, and E indicates a portion that is not described by the A-number of principal components.

When an observation vector x is decomposed by the same method as the mathematical formula 13, it becomes the following mathematical formula 15.

$$x - \underline{x} = {Q}_{a = 1}^{A} {t}_{a} {p}_{a} + {Q}_{a = A + 1}^{p} {t}_{a} {p}_{a} = \hat{x} + e \qquad ( Mathematical Formula 15 )$$

\hat{x} indicates a point that an observation vector is projected into a principal component space defined by the A-number of principal components, and e is a vector indicating a distance from an observation vector to a principal component space.

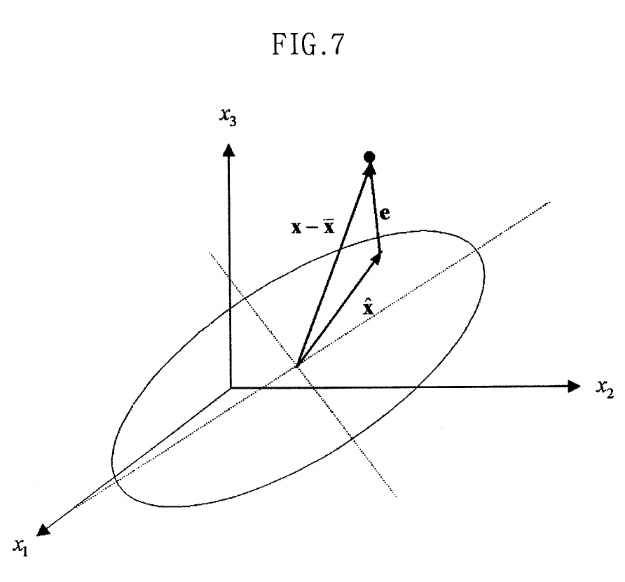

FIG. 7 illustrates a decomposed observation vector in an orthogonal coordinate system of PCA, and indicates a decomposition of the observation vector x when A is 2, as illustrated in the mathematical formula 15 set forth above. The Q statistic (Squared Prediction Error: SPE), as a scale of distance between the A-dimensional principal component space and the observation vector, can be represented by the following mathematical formula 16.

$$Q = {{Q}_{j = 1}^{p} ( {x}_{j} - {\hat{x}}_{j} )}^{2} \qquad ( Mathematical Formula 16 )$$

In a PCA control chart, when the T_{A}² statistic and the Q statistic are drawn as respective control charts, then a process can be monitored. The T_{A}² statistic of the mathematical formula 12 is a statistical distance between a point \hat{x} where an observation vector x is projected into an A-dimensional principal component space and a mean vector x. Further, the Q statistic of the mathematical formula 16 is a Euclidean distance between the A-dimensional principal component space and the observation vector x. A control limit of the T_{A}² control chart is represented by the following mathematical formula 17.

$${UCL}_{{T}_{A}^{2}} = \frac{( {n}^{2} - 1 ) A}{n ( n - A )} {F}_{a} ( A , n - A ) \qquad ( Mathematical Formula 17 )$$

A control limit of the Q control chart can be obtained from the following mathematical formula 18 through a quadratic-form approximation distribution of a multivariate normal distribution.

UCL_{Q}_{ₖ}=θ₁[1−θ₂h₀(1−h₀)/θ₁²+Zₐ(2θ₂h₀²)^{1/2}/θ₁]^{1/h}^{₀} (Mathematical Formula 18)

As provided herein θ₁=Qλⱼ, θ₂=Qλⱼ², θ₃=Qλⱼ³, h₀=1−2θ₁θ₃/3θ₂², and zₐ is a (1-a) quantile of a standard normal distribution having the same code as h₀. Further, θᵢ, i=1, 2, 3 is represented as a function of an eigenvalue λθⱼ, j=1, 2, 3 of the prediction error.

As described above, the host computer 30 collects data of process variables in a control process, and determines a reference T_{A}² control chart and a reference Q control chart and a control limit. Then, in an actual fabrication process, the host computer 30 collects data of process variables, and computes a measurement T_{A}² control chart and a measured Q control chart. The measurement T_{A}² control chart and the measured Q control chart are compared with the control limit, thus deciding a normal or abnormal state of the process being monitored.

A multivariate SPC method of a semiconductor manufacturing apparatus control system according to an exemplary embodiment of the present invention is described in more detail, as follows.

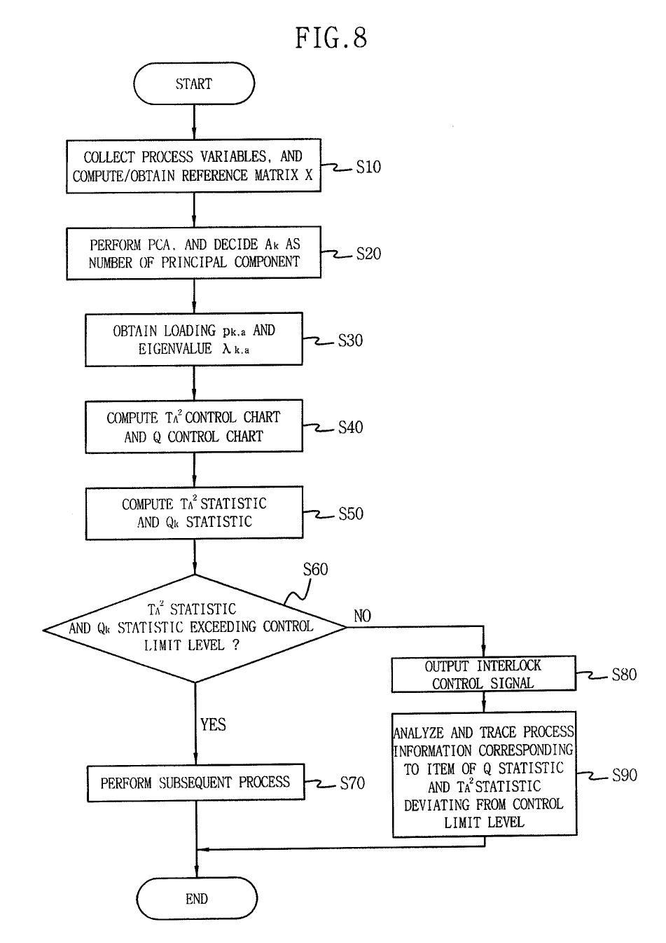

FIG. 8 is a flowchart for a multivariate SPC method of a semiconductor manufacturing apparatus control system according to an exemplary embodiment of the present invention.

As shown in FIG. 8, a multivariate SPC method of a semiconductor manufacturing apparatus control system according to an exemplary embodiment of the present invention may be classified as an offline modeling method, in which a measurement process is performed in a control state, and an online monitoring method, in which the measurement process is obtained in a fabrication state when the measurement process is actually performed.

First, in starting the offline modeling, data of one process variable is collected in a control state of a corresponding measurement process, thereby computing a reference matrix X in a step S10. For example, the modeling selection module 32 of FIG. 4 is classified as a first model in which a measurement process on each lot unit is performed, and a second model in which a measurement process is skipped according to a skip rule. Thus, subsequently, the control limit determination module 34 of FIG. 4 can compute a T_{A}² control chart and a Q control chart through respective different models. Accordingly, a multivariate SPC method for use in a semiconductor manufacturing apparatus control system according to an exemplary embodiment of the present invention can control a T_{A}² control chart and a Q control chart while varying a model applied to a process skipped according to a corresponding skip rule, thereby performing an all measurement process control, even in a skip status that a measurement of some variables is not performed and so enhancing reliability. At this time, the reference matrix X computes a mean vector x and a standard deviation vector s, thereby normalizing the reference matrix X.

Then, Aₖ as the number of principal components is decided by performing the PCA, in a step S20. There are various standards to decide the number Aₖ of principal components, including a method using a graphic such as a screen plot and tests of significance based on a correlation between process variables. For example, the number Aₖ of principal components may be decided by using a cross-validation method. In the cross-validation method, a reference matrix X (n×p) is divided into several groups, and respective groups are alternately removed from the reference matrix, and then a predicted residual sum of squares of a model established by using the remaining data is provided as a standard of decision, thereby deciding the number Aₖ of principal components.

Then, loading p_{k,a} and an eigenvalue λ_{k,a}, (k=1, . . . , K, a=1, . . . , Aₖ) are obtained in a step S30. The loading p_{k,a} and the eigenvalue λ_{k,a}, (k=1, . . . , K, a=1, . . . , Aₖ) can be easily computed by using the covariance matrix S of the mathematical formula 8.

The control limit determination module 34 of FIG. 4 determines a T_{A}² control chart and a Q control chart and respective control limits in a step S40. The T_{A}² control chart and the Q control chart can be calculated through the mathematical formulas 10 and 16, and the respective control limits can be computed through the mathematical formulas 17 and 18.

Similarly, in the online monitoring, when the observation vector x is collected thorough an actual fabrication process, the observation vector x is standardized by using a mean vector x and a standard deviation vector sₖ, and the T_{A}² statistic and the Qₖ statistic are computed in a step S50.

The abnormality sensing module 36 of FIG. 4 individually projects the T_{A}² statistic and the Qₖ statistic into the T_{A}² control chart and the Q control chart, thereby deciding whether to exceed a control limit in a step S60.

At this time, when the T_{A}² statistic and the Qₖ statistic do not exceed the control limit, it is decided that a corresponding measurement process or unit process has been performed normally, and then the subsequent measurement process and unit process are performed in a step S70.

Meanwhile, upon exceeding the control limit, it is decided as an abnormality occurrence of a corresponding measurement process or unit process, and an interlock control signal is output so as not to perform a subsequent measurement process and unit process, in a step S80.

Finally, the cause analysis module 38 of FIG. 4 analyzes information of a process variable corresponding to an item of which the T_{A}² statistic and the Qₖ statistic deviate from a control limit, and performs a feedback of corresponding information in a subsequent measurement process and unit process, in a step S90.

Consequently, in a multivariate SPC method for use in a semiconductor manufacturing apparatus control system according to exemplary embodiments of the present invention, a model corresponding to the number of process variables collected in a control process through an offline modeling is selected, thus computing the T_{A}² control chart, the Q control chart and respective control limits. Then, the T_{A}² statistic and the Qₖ statistic of process variables collected in an actual fabrication process though an online monitoring are computed, and then this is projected into the control limit, thereby clarifying in a simple fashion a normal or abnormal state in a corresponding process.

As described above, according to exemplary embodiments of the present invention, a modeling selection module is employed, in which a model is classified as a first model that a measurement process is performed for every lot unit, and a second model that a measurement process is skipped according to a skip rule. Further, a host computer for applying a T² statistic based on each model is employed, thereby obtaining all measurement process controls even in a skip status in which a measurement of some variables is not performed.

It will be apparent to those of ordinary skill in the art that modifications and variations can be made in the present invention without deviating from the spirit or scope of the invention. Thus, it is intended that the present invention cover any such modifications and variations of this invention provided they come within the scope of the appended claims and their equivalents. Accordingly, these and other changes and modifications are seen to be within the true spirit and scope of the invention as defined by the appended claims.

In the drawings and specification, there have been disclosed exemplary embodiments of the present invention and, although specific terms are employed, they are used in a generic and descriptive sense only and not for purposes of limitation, the scope of the invention being set forth in the following claims.

What is claimed is:

1. A semiconductor manufacturing apparatus control system, comprising:
a plurality of unit process devices for performing predetermined semiconductor unit processes;
a plurality of measuring devices for measuring a pattern characteristic of a wafer completed in respective semiconductor unit processes in the plurality of unit process devices; and
a host computer for sensing an abnormal state of at least one of the unit processes by using a T² statistic computed by a plurality of process variables corresponding to the pattern characteristic of the wafer measured in the plurality of measuring devices.

2. The system of claim 1, wherein the host computer comprises a modeling selection module for selecting an adequate model according to the number, type or kind of a plurality of process variables corresponding to a pattern characteristic of the wafer measured in the control process in the plurality of measuring devices; a control limit determination module for computing a T² control chart and a control limit by using the plurality of process variables selected in the modeling selection module; and an abnormality sensing module for computing the T² statistic by using the plurality of process variables corresponding to the pattern characteristic of the wafer measured in the plurality of measuring devices in a fabrication process, and checking whether there exists an item of the T² statistic deviated from the control limit, and then deciding whether the unit process has an abnormal state.

3. The system of claim 2, further comprising a cause analysis module for analyzing information of the process variable in the unit process corresponding to the item of the T² statistic deviated from the control limit when the abnormality sensing module senses an abnormality.

4. A semiconductor manufacturing apparatus control system, comprising:
a plurality of unit process devices for performing predetermined semiconductor unit processes;
a plurality of measuring devices for measuring a pattern characteristic of a wafer completed in respective unit processes in the plurality of unit process devices; and
a host computer for sensing an abnormal state of at least one of the unit processes by using a T² statistic and a Q statistic computed by a plurality of process variables corresponding to the pattern characteristic of the wafer measured in the plurality of measuring devices.

5. The system of claim 4, wherein the host computer comprises a modeling selection module for selecting an adequate model according to the number, type or kind of a plurality of process variables corresponding to a pattern characteristic of the wafer measured in the control process in the plurality of measuring devices; a control limit determination module for computing a T² control chart and a Q control chart and respective control limits by using the plurality of process variables selected in the modeling selection module; and an abnormality sensing module for computing the T² statistic and the Q statistic by using a plurality of process variables corresponding to the pattern characteristic of the wafer measured in the plurality of measuring devices in a fabrication process, and checking whether there exists an item of the T² statistic and the Q statistic deviated from the control limit, and then deciding whether the unit process has an abnormal state.

6. The system of claim 5, further comprising a cause analysis module for analyzing information of the process variable in the unit process corresponding to the item of the T² statistic deviated from the control limit when the abnormality sensing module senses an abnormality.

7. A multivariate statistical process control method for use in a semiconductor manufacturing apparatus control system, the method comprising:
collecting reference data corresponding to a surface characteristic of a wafer from a plurality of measuring devices in a control process;
determining a reference value by using the reference data;
computing a T² control chart and a control limit by using the reference value;
collecting measurement data from a plurality of measuring devices in a fabrication process; and
computing a measurement value and a T² statistic by using the measurement data, and checking whether there exists an item of the T² statistic deviated from the control limit and then deciding whether the unit process has an abnormal state.

8. The method of claim 7, wherein the reference value contains a reference matrix comprised of process variables corresponding to the reference data, and the measurement value contains a measurement matrix.

9. The method of claim 8, wherein the computation of the T² control chart and the control limit is obtained by estimating a mean vector and a covariance matrix from the reference matrix.

10. The method of claim 7, comprising, when there exists an item of the T² statistic deviated from the control limit, deciding an error occurrence in a unit process and outputting an interlock control signal so as not to perform a subsequent unit process.

11. The method of claim 10, comprising analyzing information of a process variable corresponding to the item of T² statistic deviated from the control limit, and performing a feedback of corresponding information in a subsequent unit process.

12. The method of claim 7, wherein the control limit is computed by using an F distribution of a T² control chart.

13. A multivariate statistical process control method for use in a semiconductor manufacturing apparatus control system, the method comprising:
collecting reference data corresponding to a surface characteristic of a wafer from a plurality of measuring devices in a control process;
determining a reference value by using the reference data;
computing a T² control chart and a Q control chart and respective control limits by using the reference value;
collecting measurement data from the plurality of measuring devices in a fabrication process; and
computing a measurement value and a T² statistic and a Q control chart by using the measurement data, and checking whether there exists an item of the T² statistic and the Q control chart deviated from the control limit and then deciding whether the unit process has an abnormal state.

14. The method of claim 13, wherein the reference value contains a reference matrix comprised of process variables corresponding to the reference data, and the measurement value contains a measurement matrix.

15. The method of claim 14, wherein the computation of the T² control chart and the control limit comprises deciding the number of principal components by performing a principal component analysis using the reference matrix, and computing a loading pₐ and an eigenvalue (λₐ) by using the number of principal components.

16. The method of claim 15, wherein the number of principal components is decided by using a cross-validation method.

17. The method of claim 13, comprising, when there exists an item of the T² statistic and the Q control chart deviated from the control limit, deciding an error occurrence in a unit process and outputting an interlock control signal so as not to perform a subsequent unit process.

18. The method of claim 17, comprising analyzing information of process variable corresponding to the item of the T² statistic and the Q control chart deviated from the control limit, and performing a feedback of corresponding information in a subsequent unit process.

19. The method of claim 13, wherein the control limit is computed by using an F distribution of the T² control chart and by using a quadratic-form approximate distribution of a multivariate normal distribution of the Q control chart.
